(19) United States
(12) Patent Application Publication
(10) Pub. No.: US 2015/0161571 A1
(43) Pub. Date: Jun. 11, 2015

(54) Calendar Software Interfaces and Methods

(71) Applicant: Adam Judelson, Fairfax, VA (US)

(72) Inventor: Adam Judelson, Fairfax, VA (US)

(21) Appl. No.: 14/551,135

(22) Filed: Nov. 24, 2014

Related U.S. Application Data
(60) Provisional application No. 61/913,430, filed on Dec. 9, 2013.

(51) Int. Cl. G06Q 10/10

(52) U.S. Cl. CPC G06Q 10/1095

(57) ABSTRACT

A calendar and to-do list software system, method, and user interface for operating an electronic digital computer is disclosed. Information regarding past recurring and future events, appointments, and tasks is stored in conjunction with information relating to the optimally desired frequency of the events, appointments, and tasks as well as information relating to the required amount of preparation time for future events, appointments, and tasks. Events may be displayed to the user in the form of one or more lists, for example two lists presented in side-by-side columns, one for past recurring events, appointments, and tasks, and the other for future events, appointments, and tasks. Events, appointments, and tasks may be sorted in order of a calculated priority, thereby assisting the user in determining what he or she should optimally do at the time of viewing of the calendar.

### CROSS-REFERENCE TO RELATED APPLICATIONS

This application claims the benefit of U.S. Provisional Application No. 61/913,430, filed Dec. 9, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to electronic calendar and to-do list software systems, and in particular to calendar and to-do list systems that assist the user in planning for events, appointments, and tasks. Electronic calendar and to-do list software is well-known and widely available, however such software almost universally displays events, appointments, and tasks in chronological order on a calendar over a given time period, for example one day, one week, one month or one year, depending on the desired level of detail in the particular display, view, or output template. Traditional calendar and to-do list software generally assists users in planning for events by allowing the user to set reminder notifications in advance of fixed future events. For example, a user may enter the due date of a report and set reminders to work on the report at several intervals before the due date, for example one month, two weeks, one week, and two days.

Traditional calendar and to-do list software generally does not facilitate reminders with respect to past events that ought to recur, and indeed many recurring events, appointments, or tasks are simply not entered into many calendars because the calendar is not suited to reminding users of these kinds of events, appointments, or tasks. Examples of past recurring events, appointments, or tasks that users may not enter into their traditional calendars include haircuts, routine medical and dental checkups, calling relatives and friends, vehicle maintenance, home maintenance etc. Traditional calendar and to-do list software likewise generally does not facilitate reminders with respect to future events in a way that readily takes into account the time needed to prepare for future events. Users are usually left on their own to estimate the needed preparation, as well as the overall salience of future events.

The traditional display and reminder system is inherently limited to one way of thinking about past and future events, appointments, and tasks, and the particular way in which it is limited does little to help users decide among priorities of what needs to be done today or now. This is primarily because certain useful information is typically not presented or available. Specifically the needed information is the number of days (or other unit of time) until or since a future or past event, appointment or task, information about the optimal frequency of recurring events, and information about the required amount of preparation needed for future events. A calendar system that identifies and tracks this information from a combination of user input and projection based on past data, and then displays the information to the user in such a way that relative priorities are clear would address this problem.

### SUMMARY OF THE INVENTION

Accordingly, the invention is directed to a calendar software system, method, and user interface for operating an electronic digital computer. Information regarding past recurring and future events, appointments, and tasks is stored in conjunction with information relating to the optimally desired frequency of the events, appointments, and tasks as well as information relating to the required amount of estimated preparation time for future events, appointments, and tasks. Events may be displayed to the user in the form of one or more lists, for example two lists presented in side-by-side columns, one for past recurring events, appointments, and tasks, and the other for future events, appointments, and tasks. Events, appointments, and tasks may be sorted in order of a calculated priority, which is preferably overridable or optionally not overridable by user input as to ordering, thereby assisting the user in determining what he or she should optimally do at the time of viewing of the calendar.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawing is included to provide a further understanding of the invention and is incorporated into and constitutes a part of the specification. It illustrates one embodiment of the invention and, together with the description, serves to explain the principles of the invention.

FIG. 1 is a flowchart displaying the steps of the invention pertaining to calendaring and displaying past events.

FIG. 2 is a flowchart displaying the steps of the invention pertaining to calendaring and displaying future events.

### DETAILED DESCRIPTION OF THE INVENTION

Referring now to the invention in more detail, the invention is directed to a calendar software system, method, and user interface for operating an electronic digital computer. The calendar system centers around a database of records, each having a position in time and, optionally, a duration. Records may represent any type of event, appointment, task, or other time-located thing, collectively referred to hereinafter as “events”. The system maintains awareness of the current time and date making required adjustments for time zones, daylight savings time, leap years, etc. Events positioned earlier in time than the present are hereinafter referred to as “past events”. Events positioned later in time than the present, and are hereinafter referred to as “future events”.

Each event record, whether past or future, includes a title and description of the event, and optionally additional information such as location, attendees, invitees, hyperlinks, etc. The time data for each event preferably encodes a first point in time specified by an encoded year, month, day, hour, minute, and second, though other time scales and levels of precision may be used equivalently. Where events have a duration, the first point in time may be understood as a start time, and a second point in time, similarly encoded, may be understood as the end time, with the arithmetic difference between the two being understood as the duration.

Further, events may be linked to other events that are instances of the same event, for example the user's annual physical, monthly haircut, or weekly meet-up group. By retaining linking data both forward and backward in time, the actual frequency of recurring events may be calculated by the software of the invention. Events may therefore be organized within the events database by event type, with an event type being understood as a locus of events all of the same kind that have occurred and are intended to recur at a frequency. Event types for non-recurring events, such as a report deadline, may be understood as having a single instance and no frequency or a frequency of zero. Logically, the system may be understood and applied in cases where events are allowed to be members of multiple types, events are allowed to have no type, or event types associated are allowed to be associated events; these cases may be handled according to well-established methods and do not preclude the practice of the invention.

For past events, event data may further include information relating to the desired or optimal frequency of the event. Certain events, for example having a haircut or calling a relative have an anticipated frequency that may be different for each user. Optimal frequency data may be an amalgam of user-specified frequency data with revealed frequency data, which may be calculated by averaging or otherwise combining the actual time between the events as reported by the user, and then averaging or otherwise combining the actual revealed frequency with the user's stated desired frequency to yield a composite frequency. Frequency data may also be amalgamated from a large data set of other users to reach a typical or suggested frequency, or to identify multiple modes within the distribution, which may then be presented to the user as choices or matched automatically to the user's revealed behavior. Frequencies may be expressed as a ratio of instances divided by a period of time; in the preferred embodiment, the unit of frequency is 1/days.

A frequency of a given past event type, for example the composite frequency, may be multiplied by the time elapsed since the last instance of the event type to yield a numeric urgency. An urgency of 1 may be understood as an event that is due now; urgency greater than 1 may be understood as an event that is overdue, and an urgency of less than 1 may be understood as an event that is not yet due. Different event types having different frequencies may be compared using their urgencies, with higher urgency events being generally more important to complete than events having lower urgency. Where a past event is not expected to recur and therefore has no frequency or a frequency of zero, then the event will also have no urgency or an urgency of zero; thus, the non-recurring event will always be treated as less urgent than any recurring event having a positive fractional urgency (the preferred embodiment has no interpretation of a negative value for urgency or frequency).

In the case of urgency less than 1, the event data may further include one or more minimum intervals or urgencies above or below which the user should not complete the event early, or for which additional considerations apply. For example, a user whose preferred frequency of a haircut is 30 days may reasonably want to get a haircut early at 23 days since the last haircut, but will not significantly benefit from a haircut when only 7 days have elapsed, thus the user may wish to mute the haircut event until a sufficient interval has elapsed that the user can benefit from a haircut. Correspondingly, the event data may include subsequent intervals or urgencies beyond which additional consequences or considerations apply, or beyond which the user should give up on the event as never to be usefully completed. For example, if the user has scheduled an optional contest entry that must be submitted by a deadline, and the deadline is missed or so close that the user cannot prepare the entry, then the system may mute, re-categorize, archive, trash, or remove the event as never to be completed.

Referring still to past events, for example, if the user's composite frequency for having a haircut is 1/30 days, and the elapsed time since the user's last haircut is 30 days, then the urgency is equal to 1, and accordingly is interpreted to mean that the user should have a haircut today. Correspondingly, if the elapsed time since the user's last haircut is 90 days, then the urgency is 3, which is interpreted to mean that the user is significantly overdue for a haircut. If the elapsed time since the user's last haircut is 10 days, then the urgency is 1/3, and the user is not yet due for a haircut.

In alternative embodiments, past urgency may be expressed generally as a the function F(t,b,m,s), where t is the time elapsed, b is the past behavior based on similar tasks, m is the user's manual placement, and s is the level of salience of the event to the user. In particular b and s may be collected over time from the individual or from a large data set of many users. For example, the system may record when users manually move events out of urgency order and modify the urgency for similar events accordingly. Likewise, the system may request the user to enter how salient an event is to him or her (for example a critical recurring purchase, such as baby or pet supplies, may have a high salience versus an upcoming haircut, which may have a low salience) and apply the stated salience to determine default or suggested values across the data set. The variable m denotes the user's manual placement of the event, which may always override other considerations or may instead be given strong weight in the combination function. The user's manual placement m may be represented in any of a variety of well-known data structures. The particular combination function F(t,b,m,s) may further be developed iteratively according to user feedback and recorded behavior across a large data set of users.

For future events, event data may not include a frequency (and the preferred embodiment would lack an interpretation of frequency until at least one instance of a given event type become past events). However, for future events, event data may include any number of preparation steps required for successful completion of the event, with each preparation step being fixed in time at a relative period before the event. For example, an event may be a report deadline due on a fixed date, with a first draft preparation step to be completed 7 days before, and a research preparation step to be completed 14 days before. For user interface purposes, the preparation steps may be treated as future events in their own right, except that their location in time (and optionally duration) may be defined only in relation to the event to which they apply. Data for both events and preparation steps may include an estimated preparation time, defined as a lead time immediately in advance of the time of the event or preparation step during which the user should be preparing for the event or preparation step. Events requiring no preparation may have no associated estimated preparation time or an estimated preparation time of zero.

Estimated preparation time may be hidden from the direct view of the user or omitted in favor of a substitute quantity. Since human users may have difficulty accurately assessing the amounts of estimated preparation time needed for tasks, it may be preferable to present a relative scale of difficulty or time-consumingness with which the user may designate the amount of work involved relative to other tasks. The system may convert relative time-consumingness to actual time based on revealed behavior of the user or of a large data set of many users, or may perform the below-described calculation with an abstract quantity of “preparation” substituted for an “estimated preparation time” having appropriate time units attached thereto.

Estimated preparation time is distinguished from preparation steps in that a preparation step is a means by which the user specifies a discreet point in time with specified properties, while estimated preparation time need not be more specific in content than “preparation” and generally is always represented as a duration immediately before the event or preparation step to which it relates. The estimated preparation time and content of any preparation steps may be entered by the user or established from a template of similar events, optionally by user entry or by automatic population of the events database.

Referring still to future events, in one embodiment, an urgency may be calculated by dividing the estimated preparation time for an event or preparation step by the actual time until that event or preparation step. An urgency of 1 may be understood as an event or preparation step for which preparation should begin now; urgency greater than 1 may be understood as an event or preparation step for which preparation should be ongoing, and an urgency of less than 1 may be understood as an event or preparation step for which preparation should have yet to begin. Future events may be compared using their urgencies, with higher urgency events being generally more important to complete than events having lower urgency.

In alternative embodiments, future urgency may be expressed generally as a the function F(p,t,b,m,s) where p is the estimated preparation time, t is the time until due, b is the past behavior based on similar tasks, m is the user's manual placement, and s is the level of salience of the event to the user. In particular b and s may be collected over time from the individual or from a large data set of many users. For example, the system may record when users manually move events out of urgency order and modify the urgency for similar events accordingly. Likewise, the system may request the user to enter how salient an event is to him or her (for example an upcoming examination may have high salience versus an upcoming medical checkup, which may have low salience) and apply the stated salience to determine default or suggested values across the data set. The variable m denotes the user's manual placement of the event, which may always override other considerations or may instead be given strong weight in the combination function. The user's manual placement m may be represented in any of a variety of well-known data structures. The particular combination function F(p,t,b,m,s) may further be developed iteratively according to user feedback and recorded behavior across a large data set of users.

In the case where a future event or preparation step is past due and not complete (actually scheduled in the past), the time until the event may be represented as a negative number and interpreted as the amount of time past-due. In the past-due case, urgency may be treated as irrelevant and therefore not defined since there is no remaining preparation time. In this case, the system my present a manual means of resolution by re-dating or “snoozing” the event into a new time that is in the future, with the new time being able to be entered by the user in absolute terms (a given new date and time) or in relative terms (a given interval after now). Another special case arises where the time until an event is equal to zero, since the urgency formula would divide by zero in that case; the special case may be resolved by defining all events due now (or today, where units of days are used) as more urgent than all events having a normally-defined urgency. Past-due events may be specially understood as having even higher urgency than currently due events. The above rule further addresses the case of no estimated preparation time or estimated preparation time of zero and thus having an urgency of zero, by elevating such events to due status or past due status at the appropriate time.

In use of the invention, events may be coded as past or future depending upon the properties of the event as they relate to the user, with some events being capable of being modeled according to both schemes. For example, suppose a user participates as treasurer in a social organization, and that the social group holds a weekly meeting at which the user makes a brief presentation on the group's finances for which the user must prepare the day before. In this case, the meeting may be entered into the calendar as a recurring past event with a 7-day frequency, or equivalently as a series of manually or automatically populated future events, each with a 1-day estimated preparation time. Under both methods, some, but not all, of the key features of the event are encoded. In most cases, either the past event framework or the future event framework will lend itself to coding of the particular event, however in alternative embodiments, estimated preparation time and preparation steps may be added to past recurring events, or equivalently recurrence may be added to future events to create hybrid event treatment frameworks.

The event data, thus stored, may be presented in a user interface comprising a plurality of columns or lists. Specifically, two columns or lists may be presented, one for past events and the other for future events and preparation steps. The events in each column may be sorted by highest to lowest urgency, thus presenting the user with an at-a-glance view of what he or she should be doing, working on, or preparing for, at the time of viewing. Events may be presented in additional columns or lists as divided according to properties determined by the user, or may be combined into a single combined column or list, optionally with or without normalizing or rectifying urgencies between the past event framework and future event framework.

Further, events may be grouped, tagged, or otherwise organized into an organizational structure (e.g. a hierarchical folder or tree structure or a non-hierarchical category structure) according to kind or classification, according to user preference. The organizational structure may be applied on top of or independently of the column or list view, and may be used to exclude or limit the events that are displayed. For example, the user may limit a view to specific classes of events or exclude specific classes of events, or may limit the number of events of a class that may be shown.

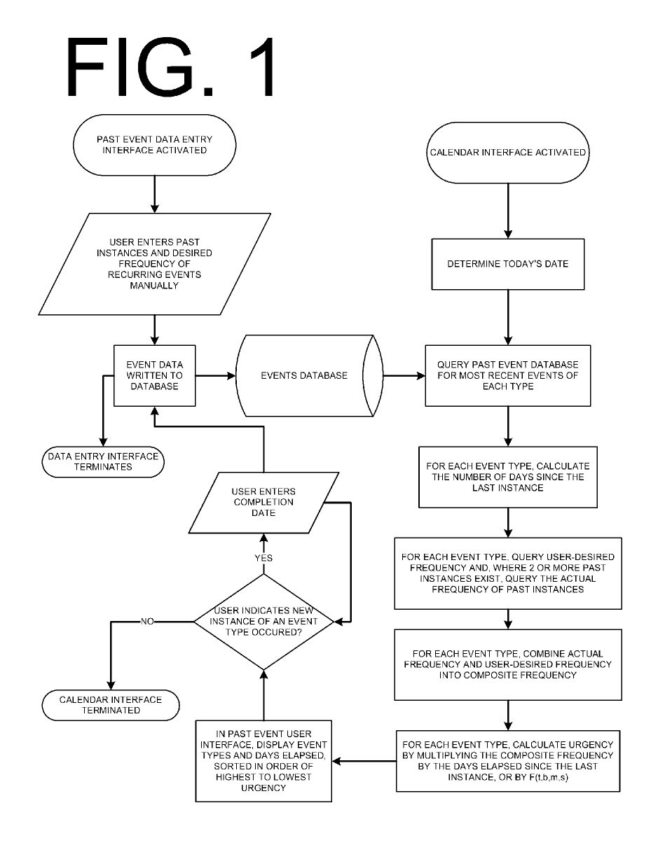

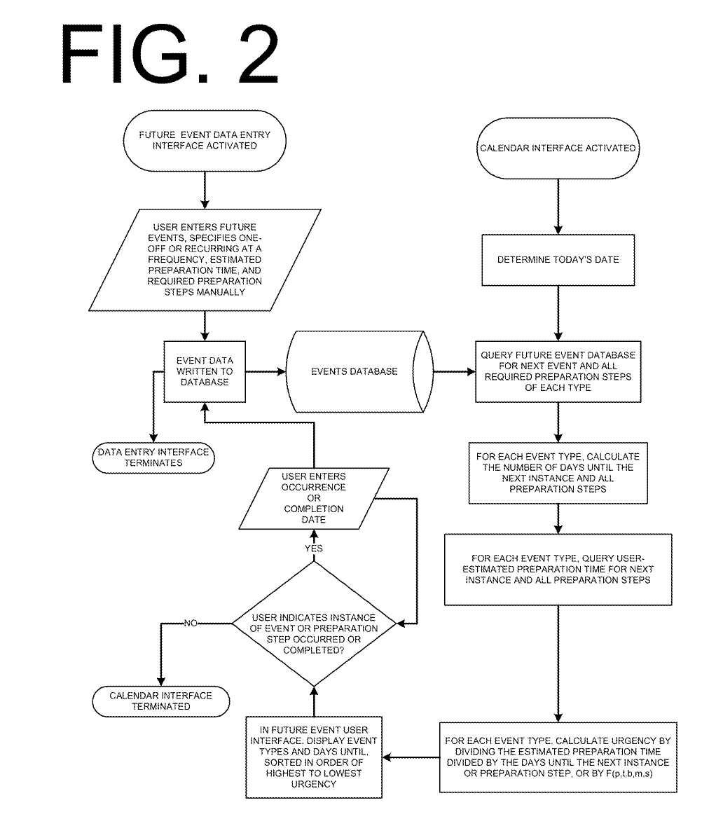

Referring now to the methods shown in FIGS. 1 and 2, FIGS. 1 and 2 are flowcharts showing the steps of the preferred embodiment. In the preferred embodiment, past and future events are treated separately, and thus the top-level or first step is to determine which framework's procedure to follow. In terms of implementation in software, the top-level decision is determined by the context from which the method is practiced. For example, when presenting a data entry interface, the start points for past event data entry (FIG. 1) or future event data entry (FIG. 2) are used. When populating one or more interface lists or columns, the calendar interface start point for past events (FIG. 1) or future events (FIG. 2) may be used.

Referring now to the past event method of FIG. 1, a software program, operable on an electronic digital computer, of the preferred embodiment (the “past event program”) first determines the current date. The past event program then queries the events database for the most recent instance of each past event type. The past event program then calculates the days elapsed since the most recent instance of each event type by subtracting the date of the most recent instance from the current date. The past event program then queries both the user-entered desired frequency and the actual past frequency for each event type, and combines the two frequencies according to a combination rule to determine a composite frequency. The combination rule may be an average, weighted average, taking one value and discarding the other, or any other rule of which many are known in the prior art. The past event program then calculates the urgency of each event type by multiplying the composite frequency by the days elapsed since the last instance of the event. In an alternative embodiment, the combination rule may be changed iteratively in order to arrive at a rule that is preferable to most users.

Referring still to the past event method of FIG. 1, the past event program, having calculated the urgencies of each event type, returns, displays, or generates the past event list by presenting the set of all event types and each of their respective urgencies, preferably in order from highest to lowest urgency. A completion interface is then presented through which the user may indicate the completion or occurrence of a new instance of an event. New instances are thus written to the database at the direction of the user, until the calendar interface is terminated, for example by the user engaging an “exit” or “quit” command, or by the past event program being manually or automatically refreshed, thus creating a new interface with updated data. The completion interface may be presented integrally within the primary user interface or a separate wizard, window, widget, or other graphical unit.

Referring now to the future event method of FIG. 2, a software program of the preferred embodiment (the “future event program”) first determines the current date. The future event program then queries the events database for all future events and preparation steps (including past-due future events). The future event program then calculates the days until each event or preparation step by subtracting the current date from the due date. The future event program then queries the estimated preparation time for each event or preparation step. The future event program then calculates the urgency of each event or preparation step by dividing the estimated preparation time by the number of days until the event or preparation step. The future event program treats zero estimated preparation time, events and preparation steps due today, and past due events and preparation steps as special cases as outlined above.

Referring still to the future event method of FIG. 2, the future event program, having calculated the urgencies of each event or preparation step, returns, displays, or generates the future event list by presenting the set of all non-completed future events or preparation steps and each of their respective urgencies, preferably in order from highest to lowest urgency, with special case urgencies of events due today and past-due events being treated as higher than normal urgency as outlined above. A completion interface is then presented through which the user may indicate the completion or occurrence of an event or preparation step. Completions or occurrences are thus written to the database at the direction of the user, until the calendar interface is terminated, for example by the user engaging an “exit” or “quit” command, or by the past event program being manually or automatically refreshed, thus creating a new interface with updated data. The completion interface may be presented integrally within the primary user interface or a separate wizard, window, widget, or other graphical unit. A completed future event may be treated by ignoring it, converting it to a past event wherein the elapsed time is tracked, or by re-spawning a new instance of the event at a time when the event might recur, the selection and specific parameters being according to user preference.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A method of calendaring and displaying past events using an electronic digital computer comprising, with reference to an events database having stored therein:
(a) a plurality of past events;
(b) each of said plurality of past events belonging to zero or more of a plurality of event types;
(c) each of said plurality of event types having associated therewith a user-entered desired frequency and an actual past frequency; and
the method comprising the steps of:
(d) determining a current date;
(e) querying said events database for the most recent of said plurality of past events belonging to each of said plurality of event types;
(f) for each of said plurality of event types, subtracting from said current date the date of the most recent of said plurality of past events belonging that of said plurality of event types, thereby yielding a days elapsed;
(g) for each of said plurality of event types, querying said user-entered desired frequency and said actual past frequency from said past events database;
(h) for each of said plurality of event types, combining said user-entered desired frequency with said actual past frequency, according to a combination rule, thereby yielding a composite frequency;
(i) for each of said plurality of event types, multiplying said composite frequency by said days elapsed, thereby yielding an urgency; and
(j) returning, displaying, or generating a past events list, said past events list comprising said plurality of event types, and, for each of said plurality of event types, said urgency.

2. A method of calendaring and displaying future events using an electronic digital computer comprising, with reference to an events database having stored therein:
(a) a plurality of future events;
(b) each of said plurality of future events having associated therewith a plurality of preparation steps; and
(c) each of said plurality of future events, and each of said plurality of preparation steps having associated therewith an estimated preparation time and a due date;
the method comprising the steps of:
(d) determining a current date;
(e) querying said events database said plurality of future events and, for each of said plurality of future events, said plurality of preparation steps;
(f) for each of said plurality of future events and each of said plurality of preparation steps, subtracting said current date from said due date, thereby yielding a days until;
(g) for each of said plurality of future events and each of said plurality of preparation steps, querying said estimated preparation time;
(h) for each of said plurality of future events and each of said plurality of preparation steps, dividing said estimated preparation time by said days until, thereby yielding an urgency; and
(i) returning, displaying, or generating a future events list, said future events list comprising said plurality of future events, for each of said plurality of future events, said plurality of preparation steps, and, for each of said plurality of future events and each of said plurality of preparation steps, said urgency.
